(19) United States
(12) Patent Application Publication
(10) Pub. No.: US 2015/0248488 A1
(43) Pub. Date: Sep. 3, 2015

(54) KEYWORD-BASED NETWORKING METHOD

(71) Applicant: ABDULNASIR D. ISMAIL, LAGOS STATE (NG)

(72) Inventor: ABDULNASIR D. ISMAIL, LAGOS STATE (NG)

(21) Appl. No.: 14/715,513

(22) Filed: May 18, 2015

Related U.S. Application Data
(63) Continuation-in-part of application No. PCT/IB2013/002578, filed on Nov. 18, 2013.
(60) Provisional application No. 61/728,176, filed on Nov. 19, 2012.

(51) Int. Cl. G06F 17/30

(52) U.S. Cl. CPC G06F 17/30864

(57) ABSTRACT

The keyword-based method can include a website accepting a first set of freely written keywords posted by a listing user who wants to be found. A searching user posts a second set of freely written keywords, which are also accepted by the website. A server-side application uses an algorithm to search for a match between first and second keyword sets. Search results are output to the listing and searching users. Matched users are connected to each other. The method can also be provided on standalone, non-networked computers.

### CROSS-REFERENCE TO RELATED APPLICATION

This application is a continuation-in-part of my prior International Patent Application Serial No. PCT/IB2013/002578, filed Nov. 18, 2013, which claims priority to U.S. Provisional Patent Application Ser. No. 61/728,176, filed Nov. 19, 2012.

### BACKGROUND OF THE INVENTION

1. Field of the Invention

The present invention relates to networking on a computer network, and particularly to a keyword-based networking method that connects users together who specify the same or similar keywords in their user profiles.

2. Description of the Related Art

Search engines that facilitate the searching of available data that may be supplied in electronic form are well known. Initially, these search engines were established by academic institutions and were configured primarily to disseminate research information and similar studies.

More recently, searching activities of this type have been deployed in more commercial environments. In particular, in response to a user's request for commercial information, possibly identifying suppliers of particular goods or services, search engines are known that can provide a list of suppliers that are available to provide goods or services of the requested type.

When services of this type have been implemented using Internet technology, it is common practice for the search results to be provided to a user without charge, thereby remaining consistent with other Internet activities. Thus, a search engine may provide a list of contacts in the form of a web page having links to supplier's websites etc. When a user accesses a supplier's website via the search material, the search provider obtains information to this effect. The service provider is then in a position to submit a charge to the advertising supplier based on the number of hits that have taken place. It is therefore advantageous from the service provider's perspective for the service to be used and for many hits to occur. A problem with this approach is that the information provided by known search engines makes the information available in a relatively dry form, does not connect interested users to each other, and as such, users are less encouraged to make active use of the service and are not attracted to particular suppliers. Furthermore, the user is often presented with long lists of data from which it is often very time-consuming and tedious to select a desired supplier's web site.

Thus, a keyword-based networking method solving the aforementioned problems is desired.

### SUMMARY OF THE INVENTION

The keyword-based networking method includes accepting a first set of freely written keywords posted by a listing user who wants to be found. A searching user posts a second set of freely written keywords, which is also accepted by the networking method. An algorithm searches for an exact match or other specified relationship between the first and second keyword sets. Search results are output to the listing users and to searching users. Listing users and searching users are connected to each other, depending on whether matching/related keyword sets were found.

These and other features of the present invention will become readily apparent upon further review of the following specification and drawings.

### BRIEF DESCRIPTION OF THE DRAWINGS

FIG. 1 is a block diagram illustrating a search portal configuration for implementing a keyword-based networking method according to the present invention.

FIG. 2 is a screenshot showing an exemplary keywords entry field in software implementing a keyword-based networking method according to the present invention.

FIG. 3 is a screenshot showing an exemplary no match results page of the search portal in software implementing a keyword-based networking method according to the present invention.

FIG. 4 is a screenshot showing an exemplary match results page of the search portal in software implementing a keyword-based networking method according to the present invention.

FIG. 5 is a screenshot showing exemplary secondary rows display of the search portal in software implementing a keyword-based networking method according to the present invention.

FIG. 6 is a screenshot showing an exemplary view page of the search portal in software implementing a keyword-based networking method according to the present invention.

FIG. 7 is a screenshot showing an exemplary detail page of the search portal in software implementing a keyword-based networking method according to the present invention.

FIG. 8 is a screenshot showing an exemplary private CEYSPACE page of the search portal in software implementing a keyword-based networking method according to the present invention.

FIG. 9 is a screenshot showing an exemplary public CEYSPACE page of the search portal in software implementing a keyword-based networking method according to the present invention.

FIG. 10 is a flowchart detailing the keyword search algorithm in a keyword-based networking method according to the present invention.

FIG. 11 is a flowchart showing the keyword search algorithm as a generalized keyword-based method according to the present invention.

Similar reference characters denote corresponding features consistently throughout the attached drawings.

### DETAILED DESCRIPTION OF THE PREFERRED EMBODIMENTS

At the outset, the inventor has chosen his own lexicon in describing the keyword-based networking method. While an attempt is made herein to provide a glossary of the inventor's special lexicon, throughout this specification words having ordinary meaning may be substituted for the special lexicon where deemed appropriate for a more complete understanding of the invention.

### DEFINITIONS

CEY: A set of space separated keywords to describe an ‘object’, which is a person, product or service. The CEY may include an optional set of media files e.g. (Text, PDF, Image, Audio, Video) to further describe the object, or software.

CEYWORDER: A user (person, company, organization) who posts or searches a CEY.

POSTCEY: A CEY that is already posted in the database.

WORKINGCEY: This is a temporarily expanded POSTCEY, depending on the searchmode. As an example, if we have a POSTCEY={big, car} and the searchmode is FULL then the WORKINGCEY={bigg, big, large, car, carr, kar, automobile}; if the searchmode is PURE then the WORKINGCEY={big, car}; if the searchmode is NO_SYNONYMS then the WORKINGCEY={bigg, big, car, carr, kar}; if the searchmode is NO_HETEROGRAPHS then the WORKINGCEY={big, large, car, automobile}.

CEYCHECK: This is a check for set inclusion of the SEARCHCEY in the WORKINGCEY of a given POSTCEY i.e. to check if the SEARCHCEY, as a set of words, is contained in the WORKINGCEY of a POSTCEY. Put differently, it is to check if every word in the SEARCHCEY can be found in the WORKINGCEY of a given POSTCEY. A CEYCHECK is always conducted against a WORKINGCEY and never against a POSTCEY itself. This is a set-based description. Equivalently, to CEYCHECK is to check if every word in the SEARCHCEY has an equal, an equal or a synonym, an equal or a heterograph, an equal or a synonym or a heterograph, depending on the searchmode, in a POSTCEY. This is a word-based description.

CEYSEARCH: This is a CEYCHECK of all POSTCEYS.

SEARCHCEY: A set of keywords which a user entered in a search box to conduct a CEYSEARCH by clicking the search button, i.e. the set of keywords being searched for.

SEARCHMODE: This is a measure of how comprehensive a search process is. There are four search modes:

FULL: here the SEARCHCEY is CEYCHECKED against a fully expanded form of each POSTCEY. For example, if we have CEY A={big, car} in our database, then a CEYSEARCH will actually be conducted against the set A′={bigg, big, large, car, carr, kar, automobile}. That is, each POSTCEY is temporarily expanded to include all the synonyms and all the heterographs of each word it actually contain and a CEYCHECK is conducted against the expanded set. This is a set-based description.

Equivalently, a FULL search is to check if every word in the SEARCHCEY has an equal or a synonym or a heterograph in a POSTCEY. This is a word-based description.

NO_HETEROGRAPHS: Here, the SEARCHCEY is CEYCHECKED against a partially expanded form of each POSTCEY which does not include heterographs. For example, if we have CEY A={big, car} in our database, then a CEYSEARCH will actually be conducted against the set A′={big, large, car, automobile}. That is, each POSTCEY is temporarily expanded to include all the synonyms of each word it actually contain and a CEYCHECK is conducted against the expanded set. This is a set-based description.

Equivalently, a NO_HETEROGRAPHS search is to check if every word in the SEARCHCEY has an equal or a synonym in a POSTCEY. This is a word-based description.

NO_SYNONYMS: Here, the SEARCHCEY is CEYCHECKED against a partially expanded form of each POSTCEY. For example, if we have CEY A={big, car} in our database, then a CEYSEARCH will actually be conducted against the set A′={bigg, big, car, carr, kar}. That is, each POSTCEY is temporarily expanded to include all the heterographs of each word it actually contain and a CEYCHECK is conducted against the expanded set. This is a set-based description.

Equivalently, a NO_SYNONYMS search is to check if every word in the SEARCHCEY has an equal or a heterograph in a POSTCEY. This is a word-based description.

PURE: Here, the SEARCHCEY is CEYCHECKED against each POSTCEY exactly as it is without any expansion whatsoever. That is, a POSTCEY and its expanded form are one and the same. The set-based and the word-based descriptions are the same in this case.

By default the results page uses the FULL searchmode. A user may them refine the search result by selecting any of the other searchmodes.

MATCHCEY: This is a POSTCEY that contains the SEARCHCEY in accordance with a CEYCHECK. As an example, if we have three CEYS A={big, car}, B={big, bicycle, car, tricycle, motorcycle} and C={large, house} then:
i—if the SEARCHCEY is {big, bicycle} and searchmode is PURE then B is a MATCHCEY and both A and C are not.
ii—if the SEARCHCEY is {big, house} and searchmode is FULL then C is a MATCHCEY and both A and B are not.
iii—if the SEARCHCEY is {big, house} and searchmode is PURE then none of A, B or C is a MATCHCEY.
iv—if the SEARCHCEY is {big} and searchmode is FULL then each of A, B and C is a MATCHCEY.

POSITIVECEY: This is a SEARCHCEY that has one or more MATCHCEYS after a CEYCHECK of all POSTCEYS For example, (big, bicycle) is a POSITIVECEY.

NEGATIVECEY: This is a SEARCHCEY that has no MATCHCEY after a CEYCHECK of all POSTCEYS. For example {small, house} is a NEGATIVECEY.

EXACTCEY: This is a MATCHCEY that has exactly the same words as the SEARCHCEY no more no less e.g. if we have three CEYS A={big, car}, B={big, bicycle, car, tricycle, motorcycle} and C={large, car} and the SEARCHCEY is {big, car} then A is an EXACTCEY and both B and C are not, no matter the searchmode.

CEYCOUNT: This is the number of EXACTCEYS in a particular CEYSEARCH.

FILTERWORD: This is a word that is part of a MATCHCEY but is not part of the SEARCHCEY e.g. if we have three CEYS A={small, car, box}, B={big, bicycle, car, tricycle, motorcycle} and C={big, large, car} and the SEARCHCEY is {big, car} then ‘bicycle’, ‘tricycle’, ‘motorcycle’, ‘large’ are all FILTERWORDS, Both ‘small’ and ‘box’ are not FILTERWORDS because A is not a MATCHCEY.

FILTERLIST: This is a list of pairs where each pair consists of a FILTERWORD and the number of MATCHCEYS containing it, e.g. if we have three CEYS A={small, car, bicycle}, B={big, large, bicycle, car, tricycle, motorcycle} and C={big, large, car, motorcycle} and the SEARCHCEY is {big, car} then the FILTERLIST associated with this CEYSEARCH will be as illustrated in Table 1.

TABLE 1
Example FILTERLIST

| FILTERWORD | number of MATCHCEYS |
|---|---|
| motorcycle | 2 |
| large | 2 |
| bicycle | 1 |
| tricycle | 1 |

NOTE: In Table 1, the ‘bicycle’ count is 1 because the ‘bicycle’ in CEY A was not counted, since CEY A is not a MATCHCEY in this case.

RESULTSET: This is a CEYCOUNT and a FILTERLIST (if it exists). It is the final output of a CEYSEARCH where the SEARCHCEY is a POSITIVECEY. The RESULTSET is sent to and displayed by the results page.

NORESULTSET: This is a list of ordered trios. The first element of each trio is a keyword that exists in at least one POSTCEY and also has an equal, or a synonym, or a heterograph, in the SEARCHCEY. The second element of each trio is the number of POSTCEYS that contain the first element, i.e. its frequency or that of its synonym, or that of its heterograph. The third element of each trio is a number (1, 2 or 3) that represents the level of the first element. If the first element is exactly equal to a keyword in the SEARCHCEY then it will have a level of 1. If it is hetero graphic to a keyword in the SEARCHCEY, then it will have a level of 2. If it is synonymous with a keyword in the SEARCHCEY then it will have a level of 3. As an example, if we have three CEYS A={small, kar, bicycle}, B={big, large, bicycle, car, tricycle, motorcycle} and C={big, large, car, motorcycle} and the SEARCHCEY is {big, green, car} then the NORESULTSET associated with this CEYSEARCH will be as shown in Table 2:

TABLE 2
Example NORESULTSET

| | Frequency of | Level of |
|---|---|---|
| Keyword | Keyword | keyword |
| big | 2 | 1 |
| car | 2 | 1 |
| kar | 1 | 2 |
| large | 2 | 3 |

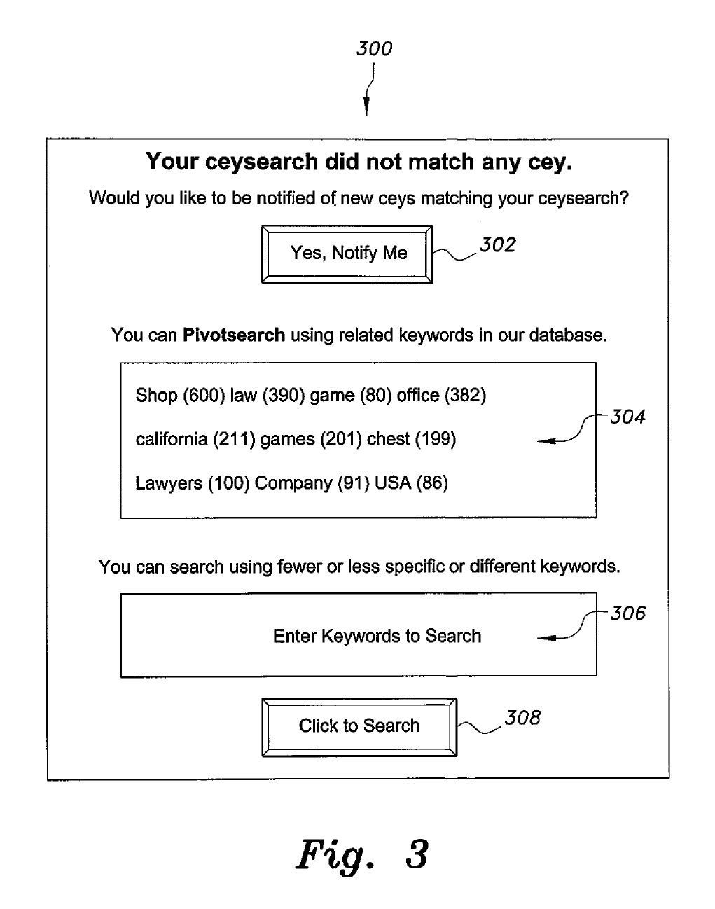

A NORESULTSET is the final output of a CEYSEARCH where the SEARCHCEY is a NEGATIVECEY. It is sent to and displayed by the results page as a tag cloud (see 304 of FIG. 3)

CURRENTCEY: This is a POSTCEY that is currently selected to be CEYCHECKED during a CEYSEARCH.

ADDFILTERLIST: This is the process of adding a pair, consisting of a FILTERWORD and 1, to the FILTERLIST if the FILTERWORD does not already exist in the FILTERLIST. If the FILTERWORD already exist in the FILTERLIST, then its frequency (the second element of the pair) is just increased by 1. Briefly described, the purpose of the CEYWORD search algorithm is to conduct a CEYSEARCH and return a RESULTSET or a NORESULTSET to the results page.

With respect to the present invention, it should be understood by one of ordinary skill in the art that embodiments of the present method can comprise software or firmware code executing on a computer, a microcontroller, a microprocessor, or a DSP processor; state machines implemented in application specific or programmable logic; or numerous other forms without departing from the spirit and scope of the method described herein. The present method can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions.

The keyword-based networking method includes the step of accepting a first set of freely written keywords posted by a listing user who wants to be found. A searching user posts a second set of freely written keywords which are also accepted by the networking method. An algorithm searches for a match between first and second keyword sets. Search results are output to the searching users.

The search algorithm checks each and every one of the posted keywords set (treating each as a distinct group) for a complete set inclusion, i.e., if, for example, we have just two posted keywords sets in the database A={a,b,c,d} and B={a,b,d,x,y,z} and a user searches for X={a,b,c}, then the algorithms object is to search both A and B to see if any of them contains {a,b,c}. It will identify A as a match and completely disregard B. It should be understood that when a user tries to post a new CEY and clicks the upload button, the CEY is not posted directly. A CEYSEARCH is conducted of this new CEY to test its uniqueness relative to pre-existing CEYS in the database. If it is indeed unique, it is saved in the database; otherwise the user is informed accordingly and advised via a prompt to edit and make it unique. In other words, two identical sets of keywords are rejected and will not be allowed to exist in the database.

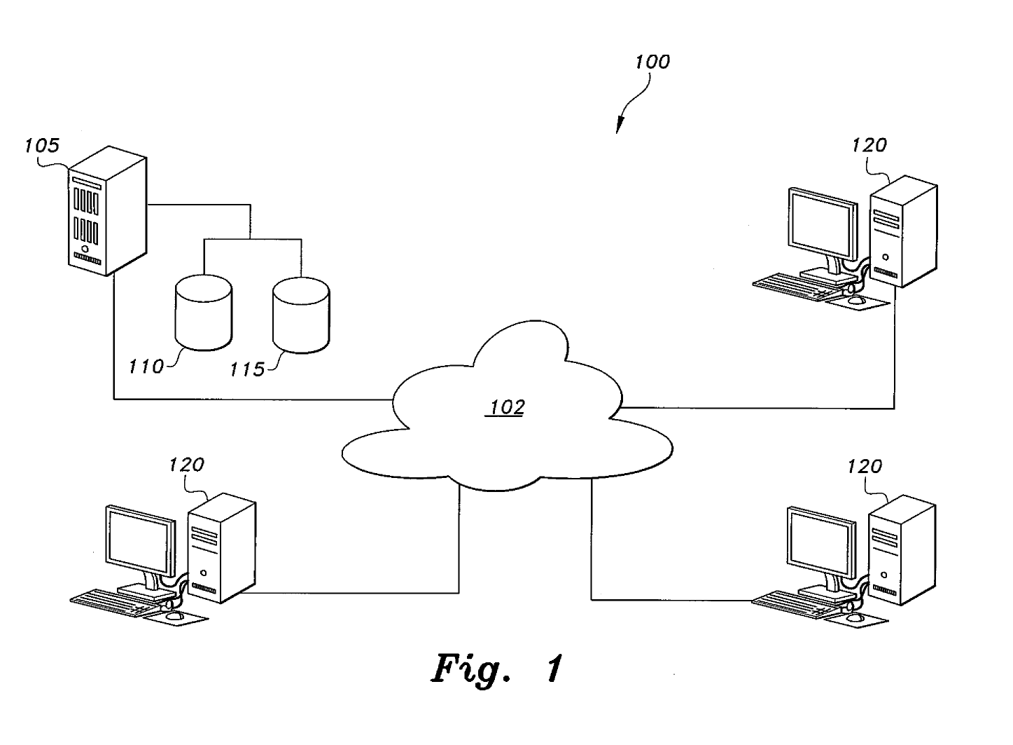

As shown in FIG. 1, an exemplary method may be implemented in a system 100 utilizing a web and application server 105 having web and application mass storage units 110 and 115, respectively. The server 105 is connected to the Internet 102. Users 120 can use the services provided by web and application server 105 by logging in to the website associated with the service. Users 120 are allowed to post keywords and also allowed to search keywords.

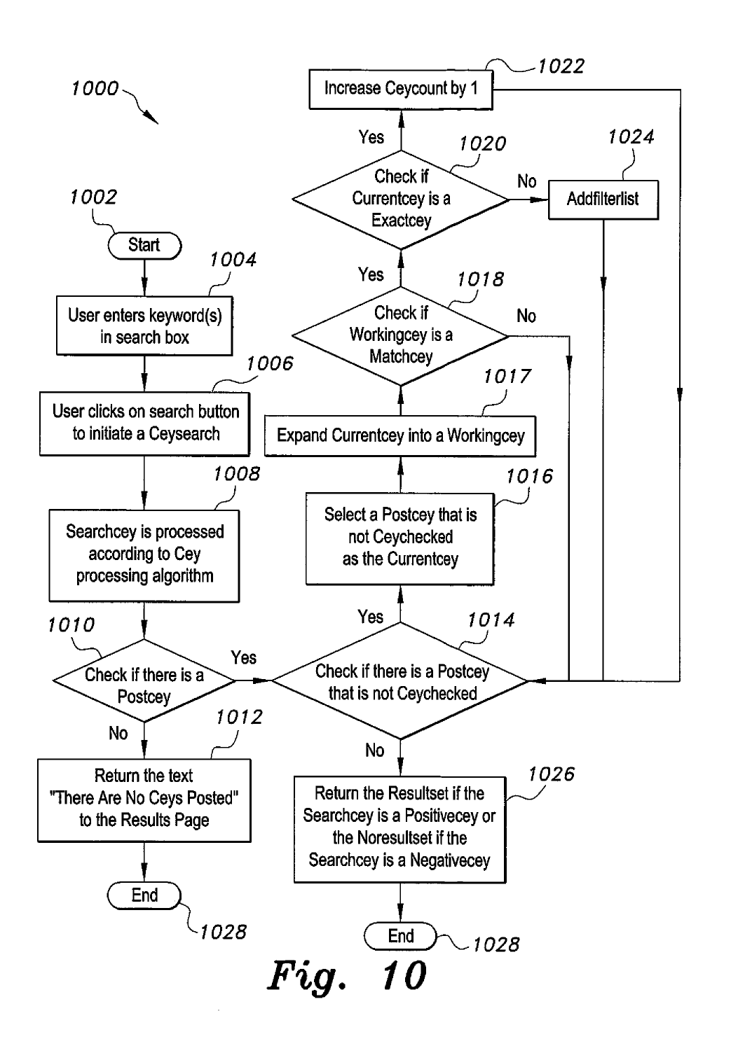

As shown in FIG. 10, the output of the algorithm includes an output element that includes the keywords that are contained in a matching posted set of keywords, but are not part of the search keywords. To illustrate, using the sets A, B, and X above, the most important output is “d” since it is contained in a matching set A={a,b,c,d} but it is not part of the search keywords X={a,b,c}.

The method also outputs the frequency of each of the output keywords relative to the matching posted keywords sets only. In our example above, “1” is the frequency of “d”. The fact that “d” exists in B is ignored.

Moreover, the method outputs the frequency of posted keywords sets that exactly match the search keywords, i.e., posted keywords sets that contain the search keywords and also have the same number of keywords as the search keywords set. In our example above, this value will be zero, but if the search keywords were to be X={a,b,c,d}, then this value will be one.

To try to overcome the realities of human communication using words, such as incorrect spelling or using synonyms to mean the same thing, the search for set inclusion may be made more flexible so that a synonym and/or a similar sounding word will be considered a match, depending on the user's chosen search mode.

Each of the output keywords is displayed on the results page so that each keyword (preferably) or its representative is clickable. This allows the user to continuously add keywords (pre-existing in the database) to his search keywords and thus achieve greater search precision.

When this keyword (or its representative) is clicked, the keyword is automatically added to the original search keywords and a new search of the expanded keywords set is conducted. Also, displayed beside each output keyword is its frequency (i.e. the second most important output element). The third element of the output (described above) is also displayed and described as “exact match” and it (or its representative) is also made clickable—if it is clicked, the user is redirected to another page to view more details about the exact matching keywords set and their associated object—CEY.

With respect to the CEY PROCESSING ALGORITHM, every set of input keywords, be they the keywords of a CEY or search keywords are processed before been saved to the database or before they are CEYSEARCHED. The steps shown in the following table make up the CEY processing algorithm:

TABLE 3
Exemplary CEY PROCESSING ALGORITHM

| STEP | ACTION |
|---|---|
| 1 | The keywords are extracted from the search box or new CEY as a |
| | string (text) for processing. |
| 2 | All keyword separators like comma “,”, semicolon “;” etc. are |
| | replaced with empty spaces “ ”. |
| 3 | All stop words like “the”, “an”, “for”, “of”, “a” etc. are replaced |
| | with empty spaces “ ”. |
| 4 | The resultant string is split into a list of keywords |
| 5 | All repeated keywords are reduced to one e.g. if we have two or |
| | more “cars”, only one is preserved in the list of keywords. |
| 6 | This list of unique keywords are then saved or processed. |

Details of the CEYSEARCH algorithm 1000 are shown in FIG. 10. At the outset, the algorithm is started at step 1002. The computer system accepts keyword entries by a user in a search box at step 1004. At step 1006 activation of a search button initiates a CEYSEARCH. At step 1008 a SEARCHCEY is processed according to the CEY processing algorithm. Step 1010 checks if there is a POSTCEY in the database. If there is no POSTCEY then at step 1012 the text “There Are No CEYS Posted” is displayed on a results page and processing is terminated at step 1028. If there is a POSTCEY, then a check is performed to determine if there is a POSTCEY that is not CEYCHECKED at step 1014. If all POSTCEYs have been CEYCHECKED, then at step 1026, a RESULTSET is returned if the SEARCHCEY is POSTIVECEY or the NORESULTSET is returned if the SEARCHCEY is a NEGATIVECEY. If the step 1014 test was affirmative, then step 1016 is performed wherein a POSTCEY is selected that has not been CEYCHECKED as the CURRENTCEY. At step 1017 the CURRENTCEY is expanded into a WORKINGCEY. At step 1018, a check is performed to see if the WORKINGCEY is a MATCHCEY. If not, then step 1014 is repeated. If affirmative, then step 1020 is performed to see if CURRENTCEY is an EXACTCEY. If negative then the ADDFILTERLIST is performed at step 1024 and step 1014 is repeated, otherwise if affirmative, then CEYCOUNT is incremented at step 1022 and step 1014 is repeated.

A CEY will also have other automatic elements, e.g., date posted. Each CEY is processed according to the CEY processing algorithm. Each CEY is saved in the application database 110 as a distinct group. A user may delete or edit a CEY. To post a CEY, a user (person, company, organization) must register with the website operator or business owner. A CEYWORDER is given the functionality to upload many different types of media files or software to our server. None, any, or all of these files many be attached to a CEY. A CEYWORDER may post any number of CEYS.

Beside each of the output keywords is displayed another clickable representative, which, when clicked, will redirect the user to a detail page that displays details about all posted keywords sets containing the current search keywords and the output keyword. Using A, B, and X above, the search for X will output “d” only. If this second clickable representative under discussion is clicked, more detailed information will be provided about A and A's associated CEY. Preferably, each keyword frequency will be made clickable and used for this purpose. There is finally a list of options which the user can use to select a search mode. If there is no match for a given search, an attempt is still made to produce a value.

Keyword-driven search engines allow users to define and/or search their “objects” within a predefined keywords structure from which users can only choose from. Hence, the word classified. Compared to these, the present method can be called unclassified. Both searches and posts use completely freely composed sets of keywords entered by the users.

A CEYSEARCH is basically a search for set inclusion i.e. if we have two CEYS in our database A={a, b, c} and B={a, y, z} then a CEYSEARCH for {a, b} is a check for CEYS that contain {a, b}. Here CEY A is a match, and CEY B is not a match. In actuality, CEYS A and B will contain words, and three types of checks will be made for each search word against every CEY in our database.

The method performs a level 1 match when each word is checked for an exact match. If an exact match does not exist for a search keyword in a given CEY, the CEY is checked for similar sounding words, i.e., heterographs. If a heterographic match exists, it is considered a level 2 match. For example, car and carr will be considered as a match. This is achieved by the soundex function or a similar function.

If there is no match according to the aforementioned matching criteria, then a check is made for synonyms, e.g., ‘big’ and ‘large’ will be considered a level 3 match. The system, by default, executes the aforementioned steps, which are detailed in search algorithm 1000. Users may then filter their search result by skipping the heterographic step, the synonymic step, or both heterographic and synonymic steps, leaving only the results for the exact matching step.

To search for a person or product or service (CEYSEARCH), a user will describe it in a search box using keywords, and click the search-button. A CEYWORDER may conduct searches from his CEYSPACE, the results page, or from the home page.

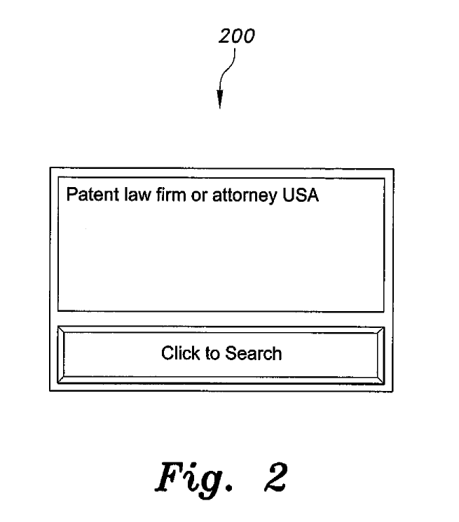

To CEYSEARCH for a law firm in the USA, a user might enter keywords as shown in screenshot 200 of FIG. 2. A click of the search-button will initiate a search of all the CEYS in database 115 for keywords matching and/or similar to the search keywords based on search algorithm 1000. Database 115 may be implemented as a relational database, or alternatively, as a key-value database. The results of the search are then shown in the results page. Either there will be a match or not.

If there is no match, the results page will display a message that there was no match, as shown in screenshot 300 of FIG. 3. Notify button 302 provides a suggestion to notify the user in the future of any new post matching this CEYSEARCH. Field 304 provides a pivotsearch option, which is a suggestion to use related keywords in the database 115. Field 306 provides a data entry field to enter fewer, less specific, or different keywords.

At this stage, a user can do one or more of three different things, such as: click the “notify me” button 302; click a word in the tag cloud 304 to search; or modify the text in the search box, and then click the search-button 308.

If the user clicks the “notify me” button 302, the keywords he is searching for are saved as a distinct group against his username. Every time a new CEY is posted, it is checked against the saved search-keywords and if there is a match in accordance with search algorithm 1000, the user is notified via email and given links to access the new CEY. This will happen only if the user has already logged in. If he has not, he will be redirected to login or register as the case need be. His search is then automatically saved after a successful login or registration.

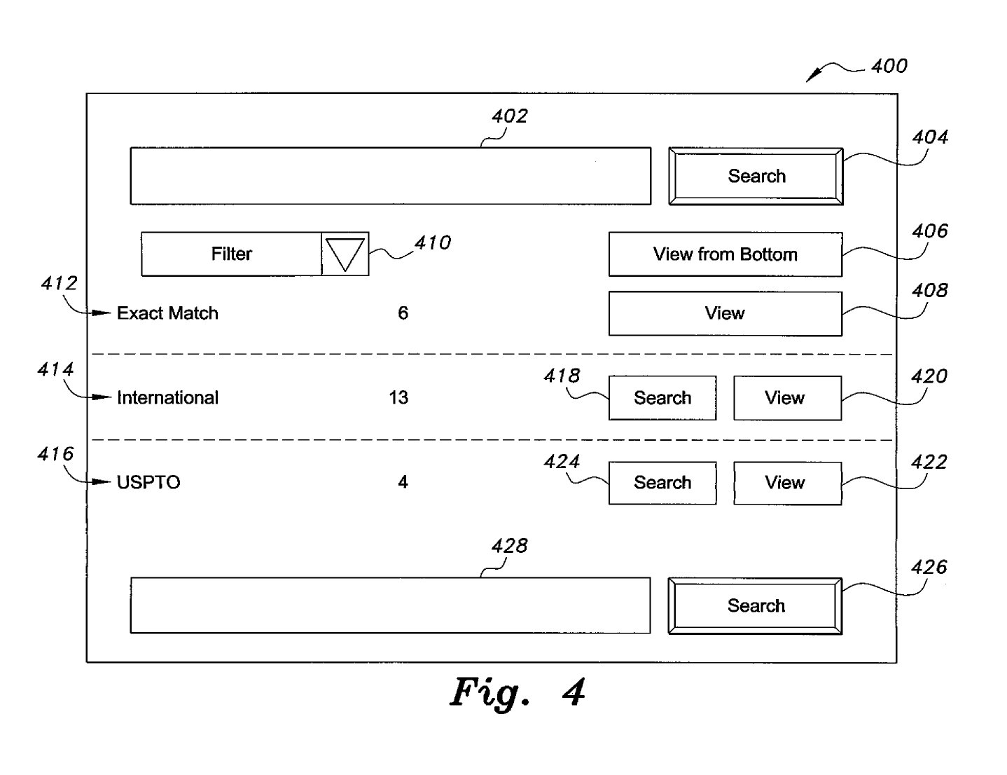

The tag cloud 304 displays a NORESULTSET with the following properties. Each keyword is written with its frequency in bracket beside it. A keyword with level 1 is bigger and bolder than a keyword with level 2 and a keyword with level 2 is bigger and bolder than a keyword with level 3. Each keyword is a hyperlink. If a keyword is clicked, it will initiate a new search of solely the clicked keyword, as if the user entered the keyword only in a search box and clicked the search button. This will ensure a result since the keyword actually exists in the database. The user may then refine the search based on other pre-existing keywords with results guaranteed. This concept of starting a search with one keyword and then refining the search with pre-existing keywords is called Pivotsearch. It demonstrates the value of the composition and format of the results page. If there is a match, the results page will display the results as shown in FIG. 4.

Screenshot 400 of FIG. 4 shows a simplified view of the results page when there is a search result. For the sake of illustration, we will assume that there are only three CEYS in the database: A={cup, chair} and B={cup, table, Chair} and C={bag, book, table, cup, chair}. NOTE: By CEYSEARCH of {cup, chair} what is meant is a CEYSEARCH of the two keywords “cup” and “chair”. The following is an explanation of the elements of the results page.

Search textbox 402 is a data entry field provided which allows a user to view search keywords and enter new search keywords in it. Search-button 404 is provided to initiate a search based on the data displayed in textbox 402. When Search button 404 is clicked, a search of the contents of the associated textbox 402 will be conducted. Search field 428 and Search button 426 duplicate this functionality at the bottom of the page of screenshot 400.

Filter dropdown-list 410 is provided to allow the user to select search-modes which customize filtering of the search results.

The primary result row 412 includes a number, (6 in this case) which shows the number of CEYS that exactly match the current CEYSEARCH. This number will be zero if there is none. Suppose a CEYSEARCH of {cup,chair} is made against our 3-CEY database, then this primary row will display 1, since only one CEY “A” has keywords that exactly match the search keywords.

The view button 408, when clicked, redirects the user to the view page, where more detailed information about each exactly matching CEY is provided.

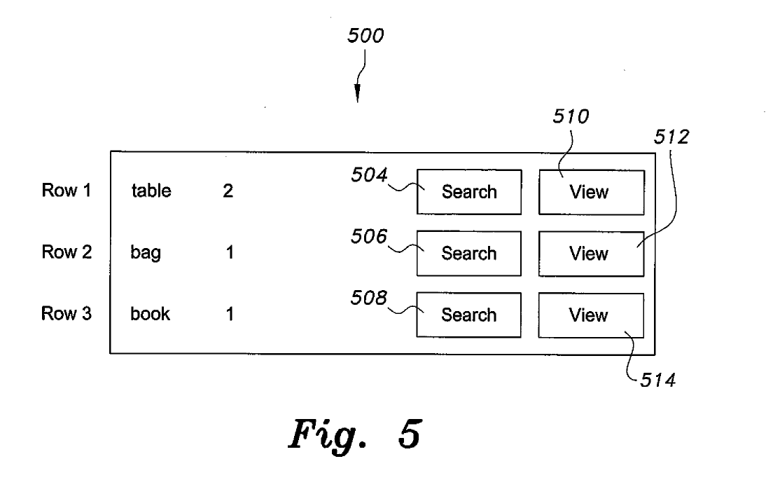

Secondary display rows 414 and 416 display information about a CEY. For example, the first word “International” means that there is at least one CEY that has all the keywords in the current CEYSEARCH and also has the keyword “International”. The number 13 next to it means that there are 13 such CEYS. Based on the exemplary 3-CEY database, three secondary rows against a CEYSEARCH of {cup,chair} are displayed in descending order of keyword frequency, as shown in screenshot 500 of FIG. 5.

Again referring to FIG. 4, a click on search-button 418 will add “international” to the current search keywords and search again. Referring to FIG. 5, while using the exemplary 3-CEY database, a click on search-button 504 will initiate a CEYSEARCH of {cup, chair, table}. A click on the search-button 506 will initiate a CEYSEARCH of {cup, chair, bag} and a click on the search-button 508 will initiate a CEYSEARCH of {cup, chair, book}. This system makes it possible for the user to refine his search by adding pre-posted keywords.

Referring to screenshot 400, clicking on search-button 424 will add “USPTO” to the current search keywords and search again. Click on view-button 420 will automatically redirect the user to the view page that provides more detailed information about CEYS that contain the current search keywords with “International” included. Using the exemplary 3-CEY database, a click on the view-button 510 in row 1 will redirect the user to the view page with details about CEYS that contain {cup, chair, table}. A click on the view-button 512 in row 2 will redirect the user to the view page with details about CEYS that contain (cup, chair, bag), and a click on the view-button 514 in row 3 will redirect the user to the view page with details about CEYS that contain {cup, chair, book}.

A click on the view button 422 of FIG. 4 will automatically redirect the user to the view page to provide more information about CEYS that contain the current search keywords with “USPTO” included. “View from bottom” button 406 enables the user to alternately view the result either in increasing or decreasing order of keyword frequency.

In summary, from the results page, a user can either conduct an entirely new search, or view details of the exact match he got in the view page, or ‘re-search’, or ‘re-search- and view-details’ in the view page. Secondary actions are sorting and navigation.

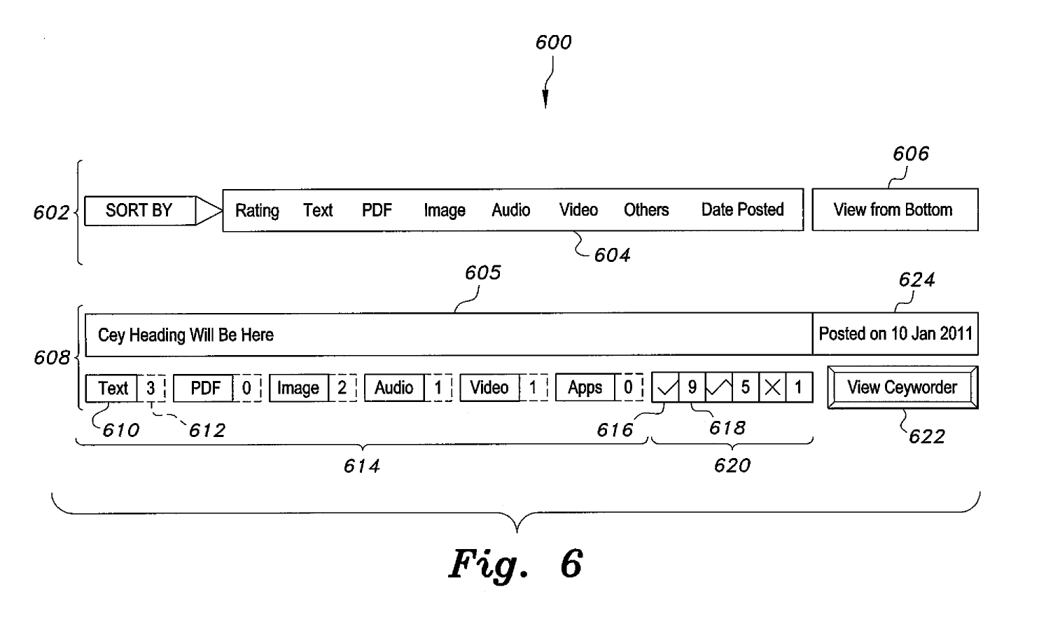

As shown in FIG. 6, the view page 600 is essentially a collection of rows, each row providing more information about each CEY that matches the current search. Users can only access the view page by clicking any of buttons 408, 420, or 422 of the search page 400. For the sake of simplicity and clarity, only one view-row is illustrated in FIG. 6.

View page 600 includes at least row types 602 and 608. A navigation row (not show in this illustration) contains buttons the user can use to navigate to other pages of a multi-page view page if all the rows cannot be shown in one page.

Row 602 is the only sorting row of view page 600. Area 604 is the sorting element of the sorting row 602 and has buttons that the user may click to sort the view rows 608 according to the number of text or PDF or image or audio or video or Archive files attached to each CEY according to field 612 of the view row 608, or sort them by their ratings according to ratings selectors 620. By default, it will arrange them in descending order of file count. If the “text” button is clicked, for example, all the CEYS are arranged so that the CEY with the highest text files count is placed at the top and so on.

Button 606 is used to alternate between viewing the sorted rows in descending or ascending order. There may be a plurality of view rows 608 depending on the number of CEYS that match the current search. View rows 608 provide more information about each matching CEY. Text box 605 contains the heading or title of a CEY as posted by the CEYWORDER. Field 624 contains the date the CEY was posted on.

A click on the View Ceyworder button 622 will redirect the user to the CEYSPACE of the CEYWORDER that posted the CEY. Screen area 620 displays other users rating of this CEY. Icon 616 symbolizes the rating of this CEY as good. The other icons to the right of this symbolize average and poor ratings, respectively.

This number “9” in field 618 means that nine other CEYWORDERS have rated this CEY as good. Five CEYWORDERS have rated it as average, and one CEYWORDER rated it as poor. Any of these values may be zero, as appropriate to the rating count.

Screen section 614 simply displays the number of the different media files associated with this CEY. The text icon 610 represents the text files associated with this CEY. It is also a clickable hyperlink, which, when clicked, will redirect the user to the details page and actually show the user the text files associated with this CEY. If the text files count 612 is 0 (zero), the hyperlink is disabled. The PDF, image, Audio, Video, Archive, and application icons will behave similarly.

This number “3” in field 612 means that there are three text files attached to this CEY. This number can be zero. Similarly no PDF file, two image files, one audio file, one video file and no application was attached to this CEY.

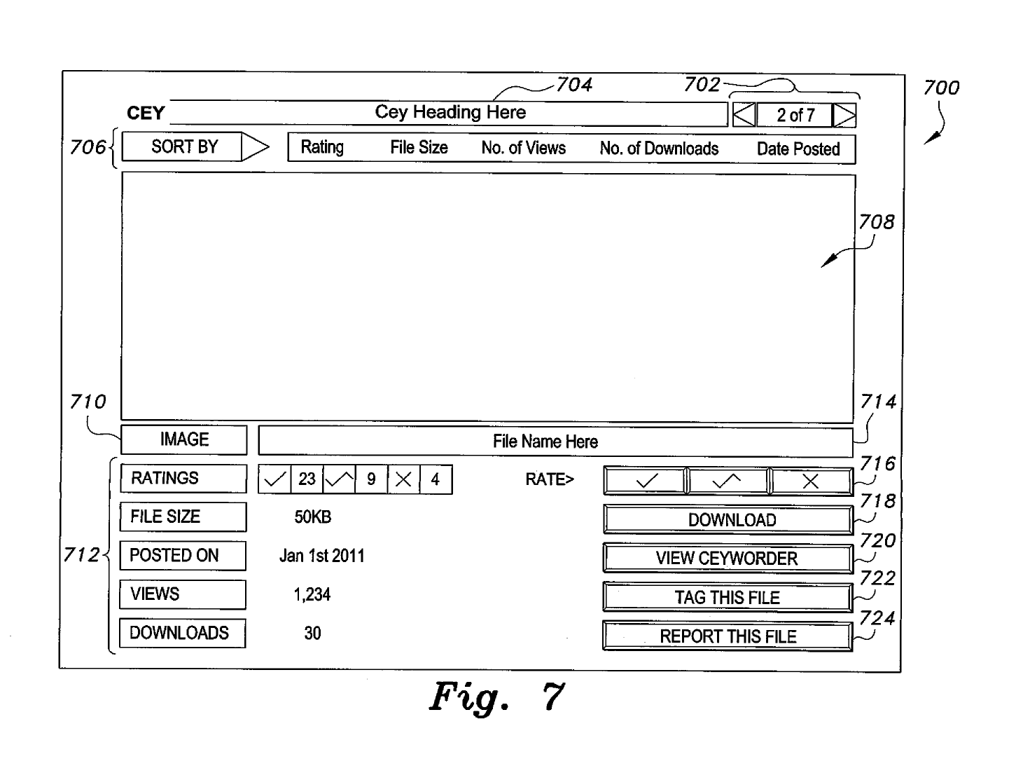

As shown in FIG. 7, the details page 700 is where the user will actually view the various files attached to a CEY. Viewing area 708 displays for the user a file (text or PDF or image or audio or video etc.) attached to the related CEY. Field 710 shows the file type being viewed. Here it is image but it could be text, PDF, audio or video. Field 714 displays the actual filename of the file being displayed in viewing area 708. Screen area 704 displays the heading of the CEY to which the file displayed in viewing area 708 is attached. Navigator bar 702 allows user to navigate the various files of a specific type, e.g., image.

Screen area 706 is the sorting element of the details page and includes buttons that the user may click to sort the arrangement of the files according to file size, number of views, number of downloads, date posted, or user rating. By default, they will be arranged in descending order. If the “Rating” button is clicked for example, all the files are arranged so that the file with the highest viewer rating is shown first. Screen area 712 provides a variety of statistical information about the file. A user (not the creator of the CEY) may use rating icons 716 to rate the file as good or average or poor. Only users that have registered and are logged in may rate a file. If a user who has not logged in should try to rate a file, he will be automatically redirected to the login page, and automatically redirected back after successful login.

A click on DOWNLOAD button 718 will initiate a download of the current file. A click on the VIEW CEYWORDER button 720 will redirect the user to the CEYSPACE of the creator of the CEY to which this file is attached. A click on the TAG THIS FILE button 722 will automatically tag the current file against the logged-in username. If a user who has not logged in should try to tag a file, he will be automatically redirected to the login page, and automatically redirected back after successful login. All tagged files will be listed in the “tagged files page” of the users CEYSPACE. If the file is offensive or inappropriate in any way, logged in users may report the file by clicking on the REPORT THIS FILE button 724.

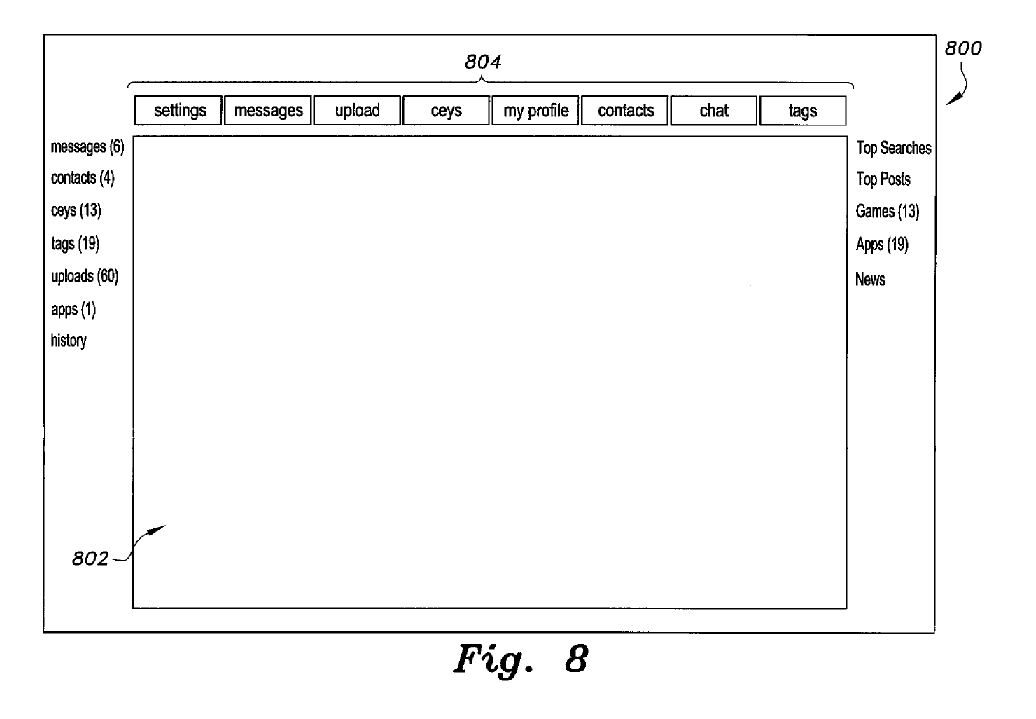

The CEYSPACE pages 800, as shown in FIG. 8, is where users can provide/view a variety of information and also perform various activities. The present method provides a private form CEYSPACE and a public form CEYSPACE.

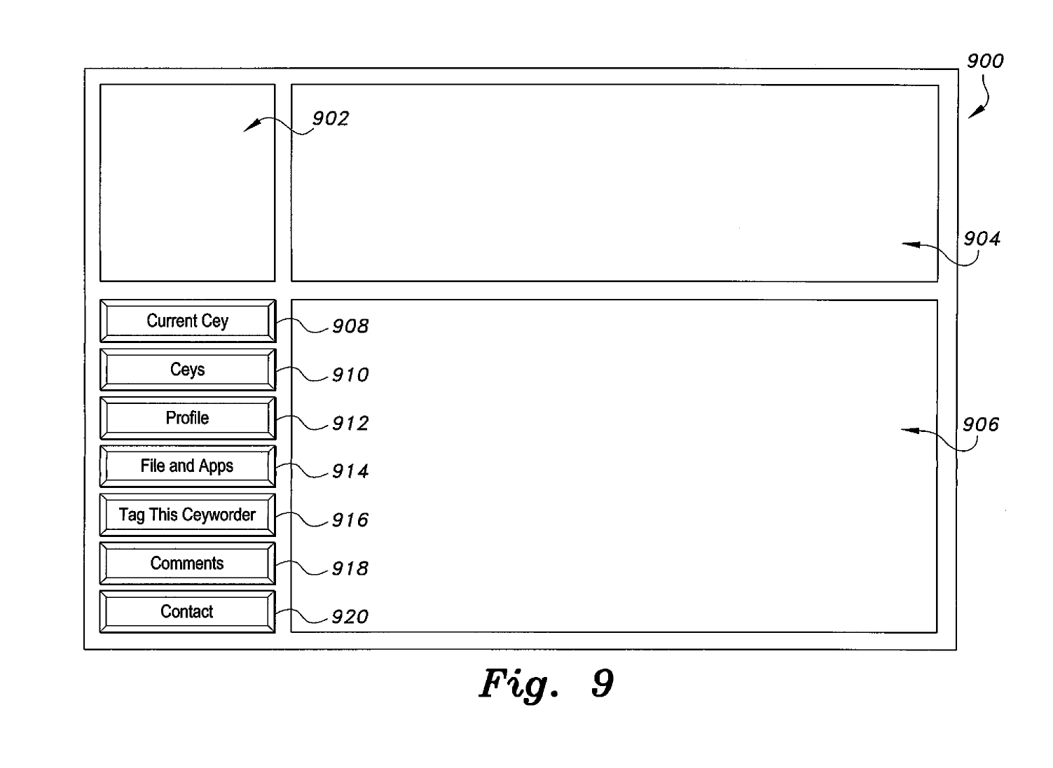

The private form CEYSPACE, shown in FIG. 8 allows a user to view his CEYSPACE. All other users only see the public form CEYSPACE 900, as shown in FIG. 9. If a user is logged in and views his CEYSPACE, he will see the private form 800.

The private CEYSPACE 800 includes a central display area 802 of the CEYSPACE that displays various functionalities as determined by user action, e.g., a click on the chat icon in screen area 804 displays the chat application in central display area 802. Screen area 804 includes a set of icons. If any of these icons is clicked by the user, its associated functionality is displayed in the central display area 802.

A click on the settings icon displays the settings page, where the user can configure the behavior of his CEYSPACE, e.g., what his default page will be, how incoming messages should be treated, and the like. A click on the messages icon will display the messages page, where the user can view and reply to messages from other users. A click on the upload icon will display the upload page, where the user can upload his files and applications. A click on the CEYS icon will display the CEYS page, where the user can view or edit or delete his CEYS and create new ones.

A click on the profile icon will display the profile page, where the user can enter defining information. This profile page will be divided into various sub-profiles, which will include, but not be limited to, physical profile, social profile, business profile, career profile, historical profile etc. The physical profile section will contain information like eye color, skin color, height, age etc. The social profile section will contain information such as interests, preferred outdoor activity, etc. The career profile section will contain such information as current project, work industry etc. The business profile section will contain such information as industry, and the like. The historical profile section will contain such information as awards, year business was founded, and the like. For each item of information, the user will either enter a value, or select a value to provide the information, or do neither. Importantly, beside each piece of information is a checkbox that the user may check to make that piece of information publicly available or uncheck to make it publicly unavailable. There is one exception to this, however. The name of the user, as provided during registration, must be publicly available. An automatic read-only CEY is created for each user. The CEY will have the name of the user as a heading. It will have only the public pieces of the profile information as keywords. It cannot be deleted, and it can only be edited by editing the profile page. This CEY will make a CEYSEARCH of the user by description possible. The profile page will also contain the user's profile picture and a comment box, where the user can write anything freely.

A click on the Contacts icon will display the contacts page, which will list all those the user have communicated with (other users), regardless of who initiated the communication. Their online status and basic information about their network activities will also be shown. Beside each contact information is a button that the user can click to hide the contact from the list. There is a button on the contact page that the user can click to show a list of all hidden contacts. A click on the chat icon will display the chat page, where the user can text-chat, audio-chat or video-chat with his contacts that are online.

A click on the tag icon will display the tags page. This is a list of all the CEYWORDERS, CEYS, and files that the user has tagged and links to them. A user may delete or hide a tag.

There are more icons for more functionalities, e.g., a search icon, which, when clicked, will display a search box and button from which a user can initiate a CEYSearch, or a comments icon, which, when clicked, the user may view all public comments made about him on his public CEYSPACE, and he may respond.

The public CEYSPACE form 900 is shown in FIG. 9 and has permissions set to allow public users to view the CEYSPACE. A user will see only the public form of his CEYSPACE if he has not logged in. Screen area 902 displays the CEYSPACE owner's profile picture, which he uploaded in his profile page. Screen area 904 displays in read-only form the CEYSPACE owner's free comments. Screen area 906 is the central area, where users can view various information about the CEYSPACE owner, among other things.

A click on the Current Cey button 908 will display, in the central area, the current CEY the user was studying that led him from the view page or the details page to this CEYSPACE.

A click on the Ceys button 910 will list in the central area all the CEYS posted by the CEYSPACE owner. A click on the Profile button 912 will display the CEYSPACE owner's public profile information in the central area 906. A click on the File and Apps button 914 will list in the central area 906 all the files and applications posted by the CEYSPACE owner.

A click on the Tag This Ceyworder button 916 will tag the CEYSPACE owner for the current user, if the current user is logged in. Otherwise, he will be redirected to the login page, and then redirected back after successful login. A click on the Comments button 918 will display in the central area 906 all the comments other users have posted about the CEYSPACE owner, and also a textbox for the current user to post his comments.

A click on the Contact button 920 will display in the central area 906 contact information about the CEYSPACE owner which will include telephone number, physical address etc. if the CEYSPACE owner so wish to make them public. It will also have buttons which when clicked will redirect the current user to his own private CEYSPACE, if he is logged in, with the new messages page or the chat page preset depending on the clicked button so that he may communicate with the CEYSPACE owner. If he is not logged in, he will be redirected to the login page, and automatically redirected back after successful login.

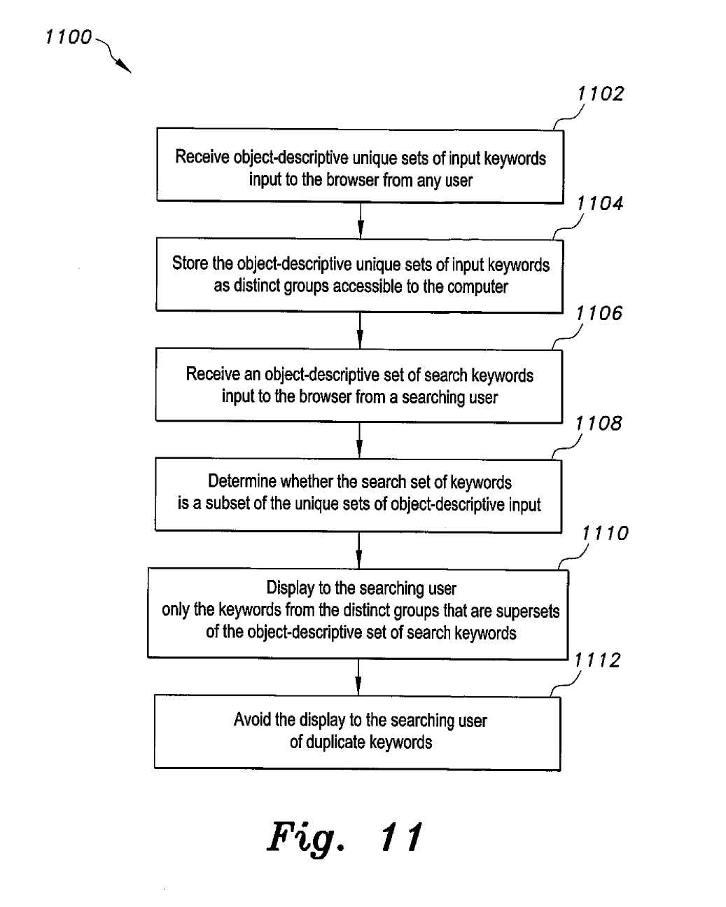

In its most generalized form, the present method, as shown in FIG. 11, may provide a computer-implemented keyword search algorithm 1100 that, irrespective of whether a computer is standalone or networked, receives object-descriptive unique sets of input keywords input to the browser from any user (step 1102), stores the object-descriptive unique sets of input keywords as distinct groups accessible to the computer (step 1104), receives an object-descriptive set of search keywords input to the browser from a searching user (step 1106), determines whether the search set of keywords is a subset of the unique sets of object-descriptive input (step 1108), displays to the searching user only keywords from the distinct groups that are supersets of the object-descriptive set of search keywords (step 1110), and avoids, i.e., suppresses the display to the searching user of duplicate keywords (step 1112). Moreover, it should be understood that when the keywords from the distinct groups that are supersets of the object-descriptive set of search keywords are displayed to the searching user, the computer-implemented keyword search algorithm 1100 may provide contact information that enables the “any user” entity and the “searching user” entity to connect via contact address, contact phone number, contact URL (as the object-descriptive sets may describe websites), or the like.

It is to be understood that the present invention is not limited to the embodiments described above, but encompasses any and all embodiments within the scope of the following claims.

I claim:

1. A computer-implemented keyword-based method, comprising the steps of:
(a) receiving object-descriptive unique sets of input keywords input to the computer from a user;
(b) rejecting any other user's attempt to input identical said input keywords wherein uniqueness of the unique sets of input keywords is maintained;
(c) storing the object-descriptive unique sets of input keywords as distinct groups accessible to the computer;
(d) receiving an object-descriptive set of search keywords input to the computer from a searching user;
(e) determining whether the search set of keywords is a subset of the unique sets of object-descriptive input keywords; and
(f) displaying to the searching user a set inclusive list consisting of keywords output from the distinct groups that are supersets of the object-descriptive set of search keywords.

2. The computer-implemented keyword-based method according to claim 1, further comprising the step of including optional sets of media files to further describe the object.

3. The computer-implemented keyword-based networking method according to claim 1, further comprising the step of outputting a frequency of each of the keywords in the displayed set inclusive list.

4. The computer-implemented keyword-based method according to claim 1, wherein the computer is connected to a network with other computers running the computer-implemented keyword-based method.

5. The computer-implemented keyword-based method according to claim 4, wherein the network is an intranet.

6. The computer-implemented keyword-based method according to claim 4, wherein the network is the Internet.

7. The computer-implemented keyword-based method according to claim 1, further comprising the step of providing contact information enabling said any user and said searching user to connect when keywords from the distinct groups that are supersets of the object-descriptive set of search keywords are displayed to the searching user.

8. The computer-implemented keyword-based method according to claim 1, further comprising the steps of:
including user-selectable search mode options defining a scope of said keyword sets, wherein said search mode options include a FULL option which provides for alternative, heterographic spellings, and synonyms in said keyword sets, and, alternatively, a PURE option, the PURE option providing for only said keyword sets as entered by the searching user;
performing a level 1 match wherein each keyword is checked for an exact match;
performing a level 2 match wherein each keyword is checked for a heterographic match; and
performing a level 3 match wherein each keyword is checked for synonyms.

9. The computer-implemented keyword-based method according to claim 1, wherein the object-descriptive sets describe websites on a network.

10. The computer-implemented keyword-based method according to claim 9, further comprising the steps of:
displaying each of the keywords in the displayed set inclusive list on a results page, each of the keywords being displayed in a user-clickable format to allow the searching user to continuously add keywords to expand the user's search keywords;
displaying beside each of the keywords a clickable representative;
redirecting, upon user clicking of the clickable representative, the user to a detail page displaying details about all posted keywords sets containing the current search keywords and the output keyword; and
wherein upon user clicking the clickable representative, user may also be redirected to the described webpage on the network.

11. The computer-implemented keyword-based method according to claim 10, further comprising the step of automatically searching the searching user's expanded search keywords.

12. The computer-implemented keyword-based method according to claim 1, further comprising the step of suppressing the display to the searching user of duplicate keywords.

13. A computer software product, comprising a non-transitory medium readable by a processor, the non-transitory medium having stored thereon a set of instructions for implementing a keyword-based method conducted using a computer, the set of instructions including:
(a) a first sequence of instructions which, when executed by the processor, causes said processor to receive object-descriptive unique sets of input keywords input to the computer from a user;
(b) a second sequence of instructions which, when executed by the processor, causes said processor to reject any other user's attempt to input identical said input keywords wherein uniqueness of said unique sets of input keywords is maintained;
(c) a third sequence of instructions which, when executed by the processor, causes said processor to store the object-descriptive unique sets of input keywords as distinct groups accessible to the computer;
(d) a fourth sequence of instructions which, when executed by the processor, causes said processor to receive an object-descriptive set of search keywords input to the computer from a searching user;
(e) a fifth sequence of instructions which, when executed by the processor, causes said processor to determine whether the search set of keywords is a subset of the unique sets of object-descriptive input keywords; and
(f) a sixth sequence of instructions which, when executed by the processor, causes said processor to display to the searching user a set inclusive list consisting of keywords output from the distinct groups that are supersets of the object-descriptive set of search keywords.

14. The computer software product according to claim 13, further comprising a seventh sequence of instructions which, when executed by the processor, causes said processor to include an optional set of media files to further describe the object.

15. The computer software product according to claim 13, further comprising an eighth sequence of instructions which, when executed by the processor, causes said processor to output a frequency of each of the keywords in the displayed set inclusive list.

16. The computer software product according to claim 13, further comprising a ninth sequence of instructions which, when executed by the processor, causes said processor to connect to a network with other computers running the computer-implemented keyword-based method, wherein said any user and said searching user may input their respective object-descriptive sets on any of the networked computers.

17. The computer software product according to claim 16, wherein the processor connects to an intranet.

18. The computer software product according to claim 16, wherein the processor connects to the Internet.

19. The computer software product according to claim 13, further comprising: a tenth sequence of instructions which, when executed by the processor, causes said processor to provide contact information enabling said any user and said searching user to connect when keywords from the distinct groups that are supersets of the object-descriptive set of search keywords are displayed to the searching user.

20. The computer software product according to claim 13, further comprising:
an eleventh sequence of instructions which, when executed by the processor, causes said processor to include user-selectable search mode options defining a scope of said keyword sets, wherein said search mode options include a FULL option which provides for alternative, heterographic spellings, and synonyms in said keyword sets, and, alternatively, a PURE option which provides for only said keyword sets as entered by the searching user; and accordingly,
a twelfth sequence of instructions which, when executed by the processor, causes said processor to perform a level 1 match wherein each keyword is checked for an exact match;
a thirteenth sequence of instructions which, when executed by the processor, causes said processor to perform a level 2 match wherein each keyword is checked for a heterographic match; and
a fourteenth sequence of instructions which, when executed by the processor, causes said processor to perform a level 3 match wherein each keyword is checked for synonyms.

21. The computer software product according to claim 13, wherein the object-descriptive sets describe websites on a network.

22. The computer software product according to claim 21, further comprising a fifteenth sequence of instructions which, when executed by the processor, causes said processor to:
display each of the keywords in the displayed set inclusive list on a results page, each of the keywords being displayed in a user-clickable format to allow the searching user to continuously add keywords to expand the user's search keywords;
display beside each of the keywords a clickable representative;
redirect, upon user clicking of the clickable representative, the user to a detail page that displays details about all posted keywords sets containing the current search keywords and the output keyword; and
wherein upon user clicking the clickable representative, user may also be redirected to the described webpage on the network.

23. The computer software product according to claim 22, further comprising a sixteenth sequence of instructions which, when executed by the processor, causes said processor to automatically search the searching user's expanded search keywords.

24. The computer software product according to claim 13, further comprising a seventeenth sequence of instructions which, when executed by the processor, causes said processor to suppress the display to the searching user of duplicate keywords.
